(19) United States
(12) Patent Application Publication
(10) Pub. No.: US 2026/0167778 A1
(43) Pub. Date: Jun. 18, 2026

(54) Process and Catalysts for Producing Polycarbosilanes for the Production of Silicon Carbide Fibers and Composites

(71) Applicant: Starfire Systems, Inc., Glenville, NY (US)

(72) Inventor: Howard Q. Shen, Albany, NY (US)

(21) Appl. No.: 18/983,064

(22) Filed: Dec. 16, 2024

(51) Int. Cl. C08G 77/60; C04B 35/571; C08G 85/00

(52) U.S. Cl. CPC C08G 77/60; C04B 35/571; C08G 85/004; C04B 2235/483; C04B 2235/5244; C04B 2235/658

(57) ABSTRACT

A method for forming polycarbosilanes used as precursors for producing silicon carbide fibers or composites includes providing poly(dimethylsilane) (PDMS) as a solid, providing a catalyst, which includes phenylboronic acid or boric acid, and reacting the solid PDMS with the catalyst at a temperature of about 340° C. for a sufficient period of time to form the polycarbosilanes. Alternatively, the method may include providing a liquid silane formed from PDMS and heating the liquid silane and the catalyst at a temperature ranging from about 100° C. to about 200° C. for about 1 to about 2 hours. After heating, reacting the liquid silane with the catalyst at a temperature ranging from about 220° C. to about 340° C. for a sufficient period of time to form the polycarbosilanes. The ceramic yield for the synthesized polycarbosilanes is in the range between about 60% to about 74% under inert gas upon heating to 1000° C.

### TECHNICAL FIELD

The present invention relates to polycarbosilanes, and more particularly to the process and catalysts of forming polycarbosilanes for the production of silicon carbide fibers and composites.

### BACKGROUND ART

Polycarbosilanes have been known for their unique applications as precursors to produce silicon carbide (SiC) ceramic fibers and composites for a long time. The first polycarbosilane (PCS) with commercial value was developed by Yajima in 1977 (1). The main structure of this polymer is predominately composed of (SiMeHCH₂) units. The synthetic process of this PCS was through a Wurtz coupling reaction of dichlorodimethylsilane with sodium in toluene or xylene under refluxed condition, followed by a rearrangement reaction of the obtained poly(dimethylsilane) (PDMS) solid at 400° C. to 470° C. in an autoclave for over 40 hours (as shown in equation 1 and 2).

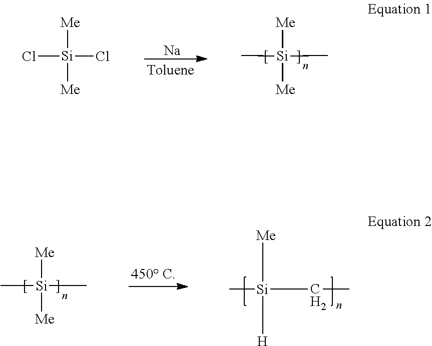

In 1980, Yajima disclosed a phenyl substituted polyborosiloxane as a catalyst for the rearrangement reaction of PDMS, which lowered the reaction temperature and decreased the reaction time (2). It also allowed the conversion reaction to occur without high pressure. However, this polyborosiloxane must be made at a very high temperature, 400° C. Another issue is that this boron polymer contains a large amount of excess free carbon, which could negatively impact the oxidation resistance of the finished SiC products at extreme temperatures. The polymerization mechanism using polyborosiloxane was through the attacks of radicals generated from the decomposition of PDMS. The Si—O—B linkages in the polyborosiloxane were thus decomposed and incorporated some —Ph₂Si—O— units into the PCS structure. The boron was released as a gaseous by-product (3).

A modified process was reported in CN 102002164 B (4), in which the PDMS powder was converted into low molecular weight liquid silane first. The liquid silane was a mixture of various cyclic silanes with a complicated structure. The liquid silane was then heated to 380° C.-470° C. for up to 50 hours without any catalyst and yielded a PCS with lower sodium content (equation 3 and equation 4). Although the synthetic yield for this process was good, 95%, the ceramic yield for the produced PCS was moderate, 55% to 61%.

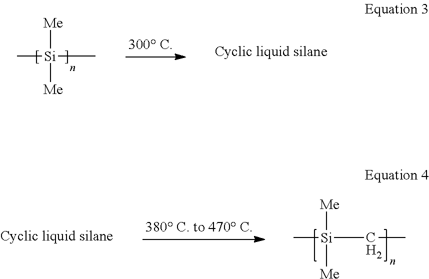

In 2015, WO2015196491 disclosed another catalyst, tris(pentalflourophenyl) boron, for the conversion reaction of liquid silane to PCS (5). This disclosure provided the benefit of lowering oxygen content in the finished polymer but added an environmentally harmful fluorine element. However, without high pressure, a long heating time from 25 to 40 hours was required for the PCS conversion reaction when using tris(pentalflourophenyl) boron as the catalyst. In addition, tris(pentalflourophenyl) boron is very expensive. Recently, a Chinese patent (6), CN 113388920, disclosed an alternative approach to preparing the polyborosiloxane catalyst originally invented by Yajima. This disclosure avoided using corrosive dichorodiphenylsilane for the preparation of the polyborosilane catalyst but did not solve the excess carbon issue. It converted PDMS powder to liquid silane first, followed by the rearrangement reaction at 350° C. to 420° C. with the newly prepared polyborosiloxane catalyst, but did not report any data for the synthetic yield and the ceramic yield for the resultant PCS. A zeolite catalyst for producing PCS from PDMS powder was reported in 2007 by U.S. Pat. No. 7,202,376(7). It took 5 days to prepare this catalyst, which was too long. In addition, this catalyst also needed to be treated at a high temperature, 500° C. No ceramic yields for the prepared PCS were reported from this patent.

In summary, without a catalyst, the conversion reaction from PDMS or liquid silane to PCS must be heated for a long time, e.g., 40 to 50 hours, and high temperature, e.g., 400° C. to 500° C. under high pressure. The existing prior art catalysts can lower the reaction temperature and reduce reaction time, but the reaction temperatures are still quite high, above 350° C. In addition, the existing catalysts cannot meet the requirements with lower carbon content, low cost, and friendly to the environment.

### SUMMARY OF THE EMBODIMENTS

In accordance with one embodiment of the invention, a method for forming polycarbosilanes used as precursors for producing silicon carbide fibers or silicon carbide composites includes providing a solid poly(dimethylsilane) (PDMS), providing phenylboronic acid or boric acid as a catalyst, and reacting the solid PDMS with the catalyst at a temperature of about 340° C. for a sufficient period of time to form the polycarbosilanes.

In related embodiments, the sufficient period of time may be about 6 hours. When the catalyst is phenylboronic acid, the phenylboronic acid has a concentration ranging from about 1 wt % to about 3 wt %. When the catalyst is boric acid, the boric acid has a concentration ranging from about 0.2 wt % to about 1.5 wt %.

In accordance with another embodiment of the invention, a method for forming polycarbosilanes used as precursors for producing silicon carbide fibers or silicon carbide composites includes providing a liquid silane formed from a poly(dimethylsilane), providing a saturated hydrocarbon substituted boronic acid, such as cyclohexyl boronic acid, an aromatic boronic acid, such as phenylboronic acid and 4-methoxy-phenyl boronic acid, or boric acid as a catalyst, heating the liquid silane and the catalyst at a temperature ranging from about 100° C. to about 200° C. for about 1 hour to about 2 hours, and after heating, reacting the liquid silane with the catalyst at a temperature ranging from about 220° C. to about 340° C. for a sufficient period of time to form the polycarbosilanes.

In related embodiments, the sufficient period of time may be about 6 hours to about 20 hours. When the catalyst is phenylboronic acid, the phenylboronic acid may have a concentration ranging from about 0.2 wt % to about 3 wt % and the temperature during reaction may be about 220° C. When the catalyst is boric acid, the boric acid may have a concentration ranging from about 0.2 wt % to about 1.5 wt % and the temperature during reacting may be about 340° C. The liquid silane may be formed by converting the PDMS powder by distillation with nitrogen purge.

In related embodiments, the method may further include removing water formed as a by-product from the catalyst and the liquid silanes by flowing nitrogen in a continuous nitrogen purge and collecting the water in a Dean Stark trap. Without removing the water, oxygen will be incorporated into the finished polycarbosilane structure, which is harmful for pyrolyzed SiC products from the oxidized polycarbosilanes. The method may further include adding 500 ppm to 5000 ppm of an antioxidant, such as 2,6-di-tert-butyl-4-methylphenol, to the polycarbosilanes to improve the shelf life of the polycarbosilanes.

In accordance with another embodiment of the invention, a method for producing polycarbosilane with different ceramic yields can be adjusted by varying the concentration of catalysts used and the reaction time. The polycarbosilanes produced may have a ceramic yield ranging from about 60% to about 74%, e.g., under an inert gas upon heating to 1000° C.

In accordance with another embodiment of the invention, a method for producing silicon carbide fibers or silicon carbide composites includes forming the polycarbosilanes according to any of the methods mentioned above and using the polycarbosilanes as precursors for making the silicon carbide fibers or the silicon carbide composites. Silicon carbide fibers or silicon carbide composites may be produced using the polycarbosilanes formed according to any of the methods mentioned above. Fibers spun from Nylon and polyester are known to be stable during handling due to their high mean molecular weight, 40000 to 50000. However, polycarbosilanes made according to the prior art have much lower mean molecular weight, 1000-2000, and fibers spun from the low molecular weight polycarbosilanes are very fragile and easily broken by hand touch (9). Fibers drawn from the polycarbosilanes with adjusted amount of catalyst disclosed in embodiments of the present invention can survive by hand touch. Polycarbosilanes made according to embodiments of the present invention with a low dose of catalysts can have a more linear structure, which can allow fibers to be spun at lower melting points, below 200° C. In addition, the boron atom plays a key role for making SiC fibers with enhanced creep characteristics according to EP 3835466 A1(10). The boron catalysts utilized in embodiments of the present invention may provide additional benefits for increasing the durability of the SiC fibers by incorporating the residue boron atoms from the polycarbosilanes made according to embodiments of the present invention into the SiC fiber structure.

### BRIEF DESCRIPTION OF THE DRAWINGS

The foregoing features of embodiments will be more readily understood by reference to the following detailed description, taken with reference to the accompanying drawings, in which:

FIG. 1 shows a process for forming polycarbosilanes using phenylboronic acid or boric acid as a catalyst and react with PDMS powder according to embodiments of the present invention; and

FIG. 2 shows another process for forming polycarbosilanes using a saturated hydrocarbon substituted boronic acid, an aromatic boronic acid, or boric acid as a catalyst and react with liquid silanes according to embodiments of the present invention.

### DETAILED DESCRIPTION OF SPECIFIC EMBODIMENTS

Embodiments of the present invention provide an improved process for forming polycarbosilanes (PCS), which are useful as precursors for the production of silicon carbide (SiC) fibers and SiC ceramic composites. The improved process of forming the PCS results in high ceramic yields for the synthetic process of forming the PCS at lower temperatures than previous arts. Embodiments of the present invention disclose small molecules, saturated hydrocarbon substituted boronic acid, such as cyclohexyl boronic acid, aromatic boronic acid, such as phenylboronic acid and 4-methoxy-phenyl boronic acid, and boric acid, as the catalyst for the conversions of liquid silane and PDMS powder to PCS. Surprisingly, the aromatic boronic acid, such as phenylboronic acid, allows the PCS conversion reaction from liquid silane to occur at substantially lower temperature, e.g., about 220° C., and to generate high ceramic yield for the resultant PCS. This low reaction temperature makes the scale up of PCS production much more convenient. Boric acid is less reactive than phenylboronic acid, e.g., at about 220° C., but works as good as phenylboronic acid at higher temperatures, e.g., about 340° C. These catalysts also convert PDMS powder directly to PCS in a short time, e.g., about 6 hours, at about 340° C. with a high ceramic yield. These catalysts are very attractive due to their substantially low cost and good catalytic reactivity. Details of illustrative embodiments are discussed below.

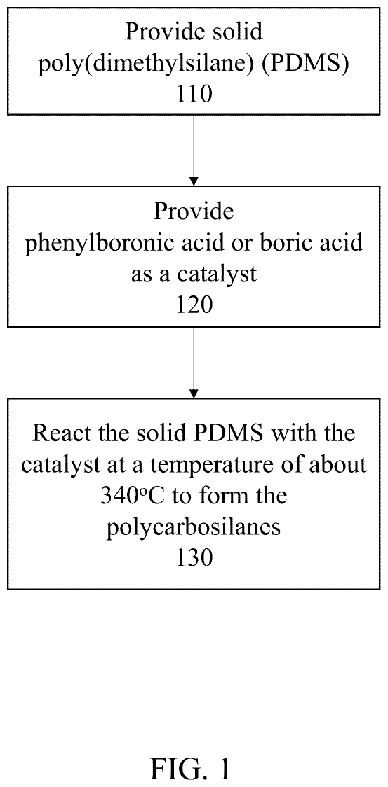

FIG. 1 shows a process for forming polycarbosilanes using phenylboronic acid or boric acid as a catalyst according to embodiments of the present invention. In step 110, a solid PDMS is provided. The solid PDMS may be formed by any known process, such as by a Wurtz coupling reaction of dichlorodimethylsilane with sodium in toluene or xylene under refluxed conditions, as known by one skilled in the art. In step 120, phenylboronic acid, PhB(OH)₂, or boric acid, H₃BO₃, is provided as a catalyst for the rearrangement reaction of PDMS. When phenylboronic acid is used as the catalyst for the PCS conversion from PDMS powder, the concentration of phenylboronic acid preferably ranges from about 1 wt % to about 3 wt %. When boric acid is used as the catalyst for the PCS conversion from PDMS powder, the concentration of boric acid preferably ranges from about 0.2 wt % to about 1.5 wt %. In step 130, the solid PDMS reacts with the phenylboronic acid or boric acid catalyst at a temperature of about 340° C. for a sufficient period of time, preferably about 6 hours, to form the polycarbosilanes.

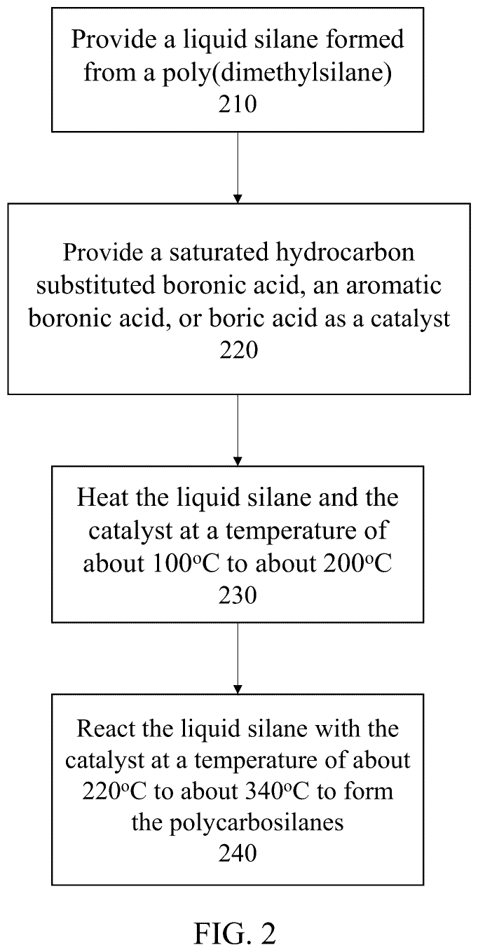

FIG. 2 shows another process for forming polycarbosilanes using saturated hydrocarbon substituted boronic acid, such as cyclohexyl boronic acid, aromatic boronic acid, such as phenylboronic acid and 4-methoxy-phenyl boronic acid, or boric acid as a catalyst according to embodiments of the present invention. In step 210, a liquid silane is provided, which is formed from solid PDMS. As mentioned above, the solid PDMS may be formed by any known process, such as by a Wurtz coupling reaction of dichlorodimethylsilane with sodium in toluene or xylene under refluxed conditions, as known by one skilled in the art. The solid PDMS is then converted to liquid silane by any known process, such as by distillation with nitrogen carrying gas, as known by one skilled in the art.

In step 220, saturated hydrocarbon substituted boronic acid, aromatic boronic acid, or boric acid is provided as a catalyst for the rearrangement reaction of the liquid silane. When phenylboronic acid is used as the catalyst for the PCS conversion from the liquid silane, the concentration of phenylboronic acid preferably ranges from about 0.2 wt % to about 3 wt %. When boric acid is used as the catalyst for the PCS conversion from the liquid silane, the concentration of boric acid preferably ranges from about 0.2 wt % to about 1.5 wt %.

In step 230, the liquid silane and the catalyst are then heated to about 100° C. to about 200° C. for about 1 hour to about 2 hours. The purpose for this relatively low temperature heating is to prepare Si—O—B linkages through condensation reactions between Si—OH groups in the liquid silane and hydroxyl groups in the catalyst (as illustrated in Equation 5 and 6 for phenylboronic acid or boric acid). Characterization of those Si—O—B linkages is difficult, but formation of water is observed during the early stage of heating. The water from the condensation reaction may be removed, for example, by flowing nitrogen, and collected in a Dean Stark trap.

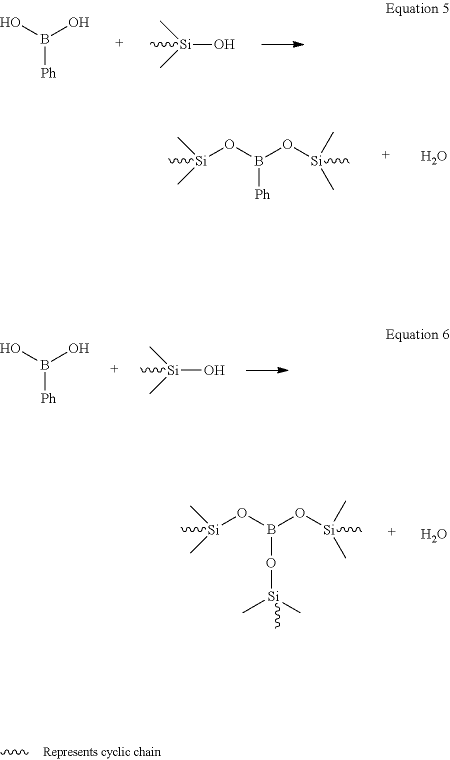

Another possible reaction mechanism forming Si—O—B linkages may occur between Si—H groups in the liquid silane and the hydroxyl groups in the catalyst (as illustrated in Equation 7 and 8 for phenylboronic acid or boric acid). Hydrogen gas may be released from this condensation reaction. Regardless of which mechanism may be involved, both mechanisms lead to the formation of the Si—O—B linkages.

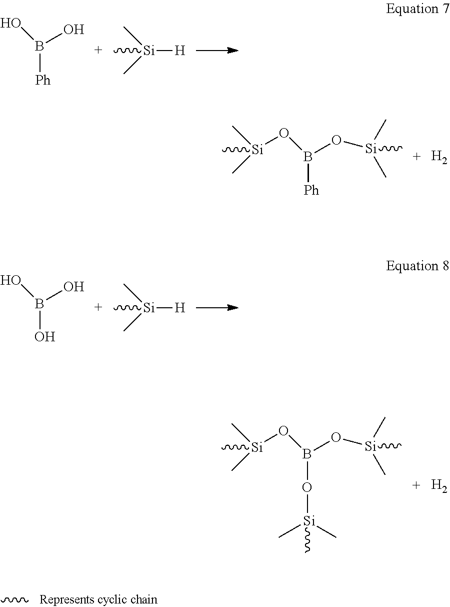

In step 240, the liquid silane reacts with the catalyst at a temperature ranging from about 220° C. to about 340° C. for a sufficient period of time to form the polycarbosilanes. When the reaction is further heated to at least 220° C., these Si—O—B linkages are believed to participate in the chain rearrangement reaction of the liquid silane. The initiation of the reaction can be observed by foaming, gas evolving, and color change of the liquid in the reaction solution. Reactivity of the catalysts can be compared by the ceramic yields of the corresponding polycarbosilanes. At 320° C., using the same quantity of catalysts (e.g., Example 8 and Example 16), the phenyl boronic acid ended with a polymer having a 45% ceramic yield, while boric acid yielded a polymer with a 30% ceramic yield. The ceramic yield from the polycarbosilane made by phenyl boronic acid at 220° C. is 63% (Example 5), while the ceramic yield for the polycarbosilane by boric acid at 220° C. is 37% (Example 15). The difference in the ceramic yields of polycarbosilanes indicates that phenyl boronic acid is much more reactive than boric acid. One reasonable explanation is that the cleaving of the C—B bond in phenylboronic acid is easier, which generates radicals and initiates polymerization of liquid silanes even at lower temperature, 220° C. Other catalysts with C—B bond, such as, 4-methoxy-phenyl boronic acid and cyclohexyl boronic acid, are also found with high reactivity at 220° C. Boric acid H₃BO₃ has no C—B bond, and it relies on the cleaving of B—O or Si—O bond to trigger the polymerization of liquid silanes at higher temperatures, above 280° C. The polyborosiloxane invented by Yajima does not contain C—B bond, either, thus it needs to be heated to above 340° C. to be active for the PCS conversion reaction.

For the catalysts, the sufficient period of time for the PCS conversion reaction from liquid silane is in the range from about 6 hours to about 20 hours with a good ceramic yield. The heating time provides varied results, especially when the concentration of the catalyst is high. As indicated in Examples 3, 10, and 12, shown below, insoluble polymers in hexane were obtained when the reactions were heated for 20 hours.

By optimizing the concentration of phenylboronic acid or boric acid catalysts and the reaction time for the PCS conversion reaction from the liquid silane or the solid PDMS, a ceramic yield ranging from about 60% to about 74% may be achieved. The finished polymers may be in the form of sticky, soft solid to glassy, hard solid, depending on the length of reaction time and the concentration of the catalyst.

Although the above discussion discloses using phenylboronic acid or boric acid, other catalysts, including saturated hydrocarbon substituted boronic acids and aromatic boronic acids as shown in the drawing below, may also be used with embodiments of the present invention. For example, cyclohexyl boronic acid is a saturated hydrocarbon substituted boronic acid, and 4-methoxy-phenyl boronic acid is an aromatic boronic acid. Both are effective catalysts with embodiments of the present invention, as shown in Example 18 and Example 19.

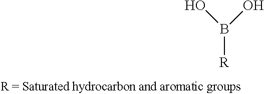

The polycarbosilanes generated with boronic acids may have a short shelf life if stored at room temperature, due to oxidation by oxygen and irradiation from light. It is likely that the residue boron catalyst in the polycarbsilanes is still active and causes further reaction, resulting in the crosslinking of the polycarbosilanes. When the polycarbosilanes generated according to embodiments of the present invention are stored at room temperature, they become insoluble in hexane and THF and cannot be melted within three weeks. However, by adding a small amount of antioxidant, 2,6-di-tert-butyl-4-methylphenol (BHT), the polycarbosilanes formed by embodiments of the present invention are still soluble in hexane and THF and can be melted after 6 months when stored at room temperature. When BHT is used as the antioxidant for the polycarbosilanes formed according to embodiments of the present invention, the concentration of BHT preferably ranges from about 500 ppm to about 5000 ppm. Using antioxidants to prolong the shelf life for the polycarbosilanes in embodiments of the present invention is not limited to BHT, other antioxidants can also be effective.

### EXAMPLES

### Example 1

Conversion of the solid poly(dimethylsilane) (PDMS) to low molecular weight liquid silane has been reported by mixing with silica under an atmospheric pressure distillation in CN 101723967⁽⁸⁾. In Example 1, a distillation was conducted by flowing nitrogen gas to the heated PDMS powder without using silica. PDMS powder (690 g), prepared by sodium coupling reaction of dichlorodimethylsilane in aromatic solvents as reported in previous literature m, was placed in a 3-liter round bottom quartz flask. A glass coated stir-bar was employed for agitation. (A Teflon coated stir-bar was not suitable for this reaction because Teflon reacts with Si—H groups at high temperatures). The stir-bar did not provide agitation at the early stage for the PDMS powder but could stir very efficiently when all PDMS melted at the later stage distillation. A nitrogen inlet tube connected to a gas flowmeter was inserted into the PDMS powder, slightly above the stir-bar. The nitrogen flow rate was set at about 500 ml/min, which carried the decomposed liquid silane out and condensed by a water condenser. A flexible fabric heating mantle was utilized to heat the 3-liter flask externally up to 370° C.-420° C. Initially, some cloudy vapor was formed when the PDMS powder began to decompose. Later, clear liquid went through the condenser and collected in a receiving flask. The temperature at the distillation head was in the range of 150° C. to 220° C., 550 g of liquid silane was isolated. The IR spectra from this liquid silane was identical to the corresponding silane as reported previously⁽⁵⁾.

### Example 2

A 500 mL three neck round bottom quartz flask was equipped with a water condenser on top of a Dean Stark trap, a thermometer, and a nitrogen inlet tube connected to a nitrogen source. A glass-coated magnetic stir-bar was used for agitating the reaction. The flask was flushed with nitrogen gas to remove oxygen and moisture, then 100 g of liquid silane prepared in Example 1 was charged together with 3 g of phenylboronic acid. The reaction system was protected by a stream of nitrogen during the reaction. The flask was heated externally and the temperature inside the flask was monitored by the thermometer. The mixture of the liquid silane and phenylboronic acid was heated for 1.5 hours between 100° C. and 200° C. All phenylboronic acid was dissolved and water formation was observed when the temperature reached 150° C. A small amount of liquid silane with water was carried away by flowing nitrogen and collected in the Dean Stark trap. As the temperature increased to 220° C., the clear solution became yellowish with foaming and gas evolving. The solution was maintained at refluxing condition and the temperature of the reaction solution gradually rose up to 330° C. in 5 hours. Then turned the heat off, the liquid inside the flask solidified with cooling. The crude solid polymer was dissolved in hexane and filtered to remove insoluble particles. Then hexane was removed by atmospheric distillation, followed by reduced pressure distillation to remove low molecular weight oligomers at the distillation head temperature up to 140° C., yielding 56 g of glassy solid polymer. TGA measurement for this polymer up to 1000° C. under argon ended with a ceramic yield of 69%. This polymer could be re-dissolved in hexane right after it was prepared.

### Example 3

The same procedures in Example 2 were followed by using 100 g of liquid silane and 3 g of phenylboronic acid. The reaction was heated for a total of 20 hours. The temperature inside the reaction flask rose up to 330° C. before the external heating was terminated. Reduced pressure distillation yielded 70 g of solid polymer. TGA measurement for this polymer up to 1000° C. under argon ended with a ceramic yield of 78%. This polymer was crosslinked during distillation and could not be re-dissolved in hexane.

### Example 4

The same procedures in Example 2 were followed by using 100 g of liquid silane and 3 g of phenylboronic acid. The temperature inside the reaction flask was maintained at 280° C. for 20 hours. Reduced pressure distillation yielded 56 g of glassy solid polymer. TGA measurement for this polymer up to 1000° C. under argon ended with a ceramic yield of 68%. This polymer could be re-dissolved in hexane right after it was prepared.

### Example 5

The same procedures in Example 2 were followed by using 100 g of liquid silane and 3 g of phenylboronic acid. The temperature inside the reaction flask was maintained at 220° C. for 20 hours. Reduced pressure distillation yielded 57 g of glassy solid polymer. TGA measurement for this polymer up to 1000° C. under argon ended with a ceramic yield of 63%. This polymer could be re-dissolved in hexane right after it was prepared.

### Example 6

The same procedures in Example 2 were followed by using 100 g of liquid silane and 3 g of phenylboronic acid. The temperature inside the reaction flask was maintained at 220° C. for 6 hours. Reduced pressure distillation yielded 59 g of glassy solid polymer. TGA measurement for this polymer up to 1000° C. under argon ended with a ceramic yield of 50%. This polymer could be re-dissolved in hexane right after it was prepared.

### Example 7

The same procedures in Example 2 were followed by using 100 g of liquid silane and 1 g of phenylboronic acid. The reaction was heated for a total of 20 hours. The temperature inside the reaction flask rose up to 330° C. before the external heating was terminated. Reduced pressure distillation yielded 57 g of glassy solid polymer. TGA measurement for this polymer up to 1000° C. under argon ended with a ceramic yield of 66%. This polymer could be re-dissolved in hexane right after it was prepared.

### Example 8

The same procedures in Example 2 were followed by using 100 g of liquid silane and 0.2 g of phenylboronic acid. The reaction was heated for a total of 20 hours. The temperature inside the reaction flask rose up to 320° C. before the external heating was terminated. Reduced pressure distillation yielded 48 g of glassy solid polymer. TGA measurement for this polymer up to 1000° C. under argon ended with a ceramic yield of 45%. This polymer could be re-dissolved in hexane right after it was prepared.

### Example 9

A 500 mL three neck round bottom quartz flask was equipped with a water condenser, a thermometer, and a nitrogen inlet tube connected to a nitrogen source. Unlike Example 2, no Dean Stark trap was connected between the condenser and the neck of the flask for this reaction. A glass-coated magnetic stir-bar was used for agitating the reaction. The flask was flushed with nitrogen gas to remove oxygen and moisture, then 100 g of PDMS powder was charged together with 1 g of phenylboronic acid. The PDMS powder and phenylboronic acid were pre-mixed before charging. The reaction system was protected by a stream of nitrogen during the reaction. The flask was heated externally to the decomposition temperature of PDMS powder. With the melting and decomposing of PDMS powder, liquid refluxing and foaming were observed between 260° C. to 320° C. inside the flask. Gas evolving occurred rapidly at this temperature range and was carried away by the flowing nitrogen. With the progress of the reaction, the gas evolving gradually became slow and eventually stopped. The materials in the flask were maintained at reflux for a total of 5 hours and the temperature inside the reaction flask rose up to 340° C. at the end of the reaction. After turning the heat off, the liquid inside the flask solidified with cooling. This crude solid polymer was extracted by hexane and filtered to remove insoluble particles. Then hexane was removed by atmospheric distillation, followed by reduced pressure distillation to remove low molecular weight oligomers at the distillation head temperature up to 140° C., yielding 59 g of glassy solid polymer. TGA measurement for this polymer up to 1000° C. under argon ended with a ceramic yield of 60%. This polymer could be re-dissolved in hexane right after it was prepared.

### Example 10

The same procedures in Example 9 were followed by using 100 g of PDMS powder and 3 g of phenylboronic acid. The reaction was heated for a total of 6 hours. The temperature inside the reaction flask rose up to 340° C. before the external heating was terminated. The crude solid polymer was extracted by hexane and filtered to remove insoluble particles. Due to using more catalysts than Example 9, more insoluble particles were generated, only 47 g of brittle solid polymer were obtained from the extracted solution. TGA measurement for this polymer up to 1000° C. under argon ended with a ceramic yield of 75%. This polymer was crosslinked during distillation and could not be re-dissolved in hexane.

### Example 11

A 500 mL three neck round bottom quartz flask was equipped with a water condenser on top of a Dean Stark trap, a thermometer, and a nitrogen inlet tube connected to a nitrogen source. A glass-coated magnetic stir-bar was used for agitating the reaction. The flask was flushed with nitrogen gas to remove oxygen and moisture, then 100 g of liquid silane prepared in Example 1 was charged together with 1.5 g of boric acid. The reaction system was protected by a stream of nitrogen during the reaction. The flask was heated externally and the temperature inside the flask was monitored by the thermometer. The mixture of the silane and boric acid was heated for 1.5 hours between 100° C. and 200° C. Water formation was observed at this temperature range and was carried away by the flowing nitrogen. A small amount of evaporated liquid silane with water was collected in the Dean Stark trap. The materials in the flask were further heated to reflux and the temperature of the reaction solution gradually went up to 330° C. in 5 hours. After turning the heat off, the liquid inside the flask solidified with cooling. The crude solid polymer was dissolved in hexane and filtered to remove insoluble particles. Then hexane was removed by atmospheric distillation, followed by reduced pressure distillation to remove low molecular weight oligomers at the distillation head temperature up to 140° C., yielding 52 g of glassy solid polymer. TGA measurement for this polymer up to 1000° C. under argon ended with a ceramic yield of 57%. This polymer could be re-dissolved in hexane right after it was prepared.

### Example 12

The same procedures in Example 11 were followed by using 100 g of liquid silane and 1.5 g of boric acid. The reaction was heated for a total of 20 hours. The temperature inside the reaction flask rose up to 340° C. before the external heating was terminated. Reduced pressure distillation yielded 61 g of brittle solid polymer. TGA measurement for this polymer up to 1000° C. under argon ended with a ceramic yield of 71%. This polymer was crosslinked during distillation and could not be re-dissolved in hexane.

### Example 13

The same procedures in Example 11 were followed by using 100 g of liquid silane and 1 g of boric acid. The reaction was heated for a total of 20 hours. The temperature inside the reaction flask rose up to 340° C. before the external heating was terminated. Reduced pressure distillation yielded 62 g of glassy solid polymer. TGA measurement for this polymer up to 1000° C. under argon ended with a ceramic yield of 74%. This polymer could be re-dissolved in hexane right after it was prepared.

### Example 14

The same procedures in Example 11 were followed by using 100 g of liquid silane and 1 g of boric acid. The temperature inside the reaction flask was maintained at 280° C. for 20 hours. Reduced pressure distillation yielded 58 g of glassy solid polymer. TGA measurement for this polymer up to 1000° C. under argon ended with a ceramic yield of 53%. This polymer could be re-dissolved in hexane right after it was prepared.

### Example 15

The same procedures in Example 11 were followed by using 100 g of liquid silane and 1 g of boric acid. The temperature inside the reaction flask was maintained at 220° C. for 20 hours. Reduced pressure distillation yielded 52 g of sticky soft solid polymer. TGA measurement for this polymer up to 1000° C. under argon ended with a ceramic yield of 37%. This polymer could be re-dissolved in hexane right after it was prepared.

### Example 16

The same procedures in Example 11 were followed by using 100 g of liquid silane and 0.2 g of boric acid. The reaction was heated for a total of 20 hours. The temperature inside the reaction flask rose up to 320° C. before the external heating was terminated. Reduced pressure distillation yielded 46 g of sticky soft solid polymer. TGA measurement for this polymer up to 1000° C. under argon ended with a ceramic yield of 30%. This polymer could be re-dissolved in hexane right after it was prepared.

### Example 17

A 500 mL three neck round bottom quartz flask was equipped with a water condenser, a thermometer, and a nitrogen inlet tube connected to a nitrogen source. Unlike Example 2, no Dean Stark trap was connected between the condenser and the neck of the flask for this reaction. A glass-coated magnetic stir-bar was used for agitating the reaction. The flask was flushed with nitrogen gas to remove oxygen and moisture, then 100 g of PDMS powder was charged together with 1 g of boric acid. The PDMS powder and boric acid were pre-mixed before charging. The reaction system was protected by a stream of nitrogen during the reaction. The flask was heated externally to the decomposition temperature of PDMS powder. With the melting and decomposing of PDMS powder, liquid refluxing and foaming were observed between 260° C. to 320° C. inside the flask. Gas evolving occurred rapidly at this temperature range and was carried away by the flowing nitrogen. With the progress of the reaction, the gas evolving gradually became slow and eventually stopped. The materials in the flask were maintained at reflux for 5 hours and the temperature inside the reaction flask rose up to 340° C. at the end of the reaction. After turning the heat off, the liquid inside the flask solidified with cooling. The crude solid polymer was dissolved in hexane and filtered to remove insoluble particles. Then hexane was removed by atmospheric distillation, followed by reduced pressure distillation to remove low molecular weight oligomers at the distillation head temperature up to 140° C., yielding 60 g of glassy solid polymer. TGA measurement for this polymer up to 1000° C. under argon ended with a ceramic yield of 66%. This polymer could be re-dissolved in hexane right after it was prepared.

### Example 18

The same procedures in Example 2 were followed by using 100 g of liquid silane and 2.5 g of cyclohexyl boronic acid. Gas evolving and foaming in the reaction mixture were observed at 220° C., which indicated the initiation of polymerization. The temperature inside the reaction flask was maintained at 220° C. for 20 hours. Reduced pressure distillation yielded 58 g of glassy solid polymer. TGA measurement for this polymer up to 1000° C. under argon ended with a ceramic yield of 49%. This polymer could be re-dissolved in hexane right after it was prepared.

### Example 19

The same procedures in Example 2 were followed by using 100 g of liquid silane and 2.5 g of 4-methoxy-phenylboronic acid. Gas evolving and foaming in the reaction mixture were observed at 195° C., which indicated the initiation of polymerization. After the gas evolving slowed down, the temperature inside the reaction flask was maintained at 220° C. for 20 hours. Reduced pressure distillation yielded 58 g of glassy solid polymer. TGA measurement for this polymer up to 1000° C. under argon ended with a ceramic yield of 59%. This polymer could be re-dissolved in hexane right after it was prepared.

### Example 20

10 g of polycarbosilane prepared in Example 5 was mixed with 0.02 g of BHT in a 50 mL round bottom flask under nitrogen protection. The mixture was heated to a melt state, stirred for 5 min magnetically, and then cooled down to room temperature. The obtained solid was soluble in hexane and THF after stored at room temperature for 6 months. The obtained solid can also be re-melted after being stored 6 months at room temperature. Without adding BHT, polycarbosilane made from Example 5 became insoluble in hexane and THF in three weeks and cannot be melted after three weeks.

Although the above discussion discloses various exemplary embodiments, those skilled in the art may make various modifications to, or variations of, the illustrated embodiments without departing from the inventive concepts disclosed herein.

### REFERENCES

1. U.S. Pat. No. 4,052,430, (1977)
2. U.S. Pat. No. 4,220,600, (1980)
3. S. Yajima, Y. Hasegawa, K. Okamura, and T. Matsuzawa, Nature, Pages 525-527, vol. 273, (1978)
4. CN 102002164 B, (2012)
5. WO 2015196491, (2015)
6. CN 113388920, (2022)
7. U.S. Pat. No. 7,202,376 B2 (2007)
8. CN 101723967 A (2010)
9. T. Ishikawa, Composites Science and Technology, Pages 135-144, vol 51, (1994)
10. EP 3835466 A1 (2021)

What is claimed is:

1. A method for forming polycarbosilanes used as precursors for producing silicon carbide fibers or silicon carbide composites, the method comprising:
providing a solid poly(dimethylsilane) (PDMS);
providing phenylboronic acid or boric acid as a catalyst; and
reacting the solid PDMS with the catalyst at a temperature of about 340° C. for a sufficient period of time to form the polycarbosilanes.

2. The method of claim 1, wherein the sufficient period of time is about 6 hours.

3. The method of claim 1, wherein the catalyst is phenylboronic acid with a concentration ranging from about 1 wt % to about 3 wt %.

4. The method of claim 1, wherein the catalyst is boric acid with a concentration ranging from about 0.2 wt % to about 1.5 wt %.

5. A method for forming polycarbosilanes used as precursors for producing silicon carbide fibers or silicon carbide composites, the method comprising:
providing a liquid silane formed from a poly(dimethylsilane);
providing a saturated hydrocarbon substituted boronic acid, an aromatic boronic acid, or boric acid as a catalyst;
heating the liquid silane and the catalyst at a temperature ranging from about 100° C. to about 200° C. for about 1 hour to about 2 hours; and
after heating, reacting the liquid silane with the catalyst at a temperature ranging from about 220° C. to about 340° C. for a sufficient period of time to form the polycarbosilanes.

6. The method of claim 5, wherein the sufficient period of time is about 6 hours to about 20 hours.

7. The method of claim 5, wherein the aromatic boronic acid catalyst is phenylboronic acid having a concentration ranging from about 0.2 wt % to about 3 wt %.

8. The method of claim 7, wherein the temperature during reacting is about 220° C.

9. The method of claim 5, wherein the catalyst is boric acid having a concentration ranging from about 0.2 wt % to about 1.5 wt %.

10. The method of claim 9, wherein the temperature during reacting is about 340° C.

11. The method of claim 5, further comprising removing water formed as a by-product by flowing nitrogen and collecting the water in a Dean Stark trap.

12. The method of claim 5, wherein the liquid silane is formed by converting the poly(dimethylsilane) from a solid by distillation with nitrogen purging.

13. The method of claim 5, wherein the aromatic boronic acid catalyst is 4-methoxy-phenyl boronic acid.

14. The method of claim 5, wherein the saturated hydrocarbon substituted boronic acid catalyst is cyclohexyl boronic acid.

15. The method of claim 5, further comprising adding 500 ppm to 5000 ppm of an antioxidant to the polycarbosilanes.

16. The method of claim 15, wherein the antioxidant is 2,6-di-tert-butyl-4-methylphenol.

17. A method for producing silicon carbide fibers or silicon carbide composites, the method comprising:
forming the polycarbosilanes according to claim 1; and
using the polycarbosilanes as precursors for making the silicon carbide fibers or the silicon carbide composites.

18. A method for producing silicon carbide fibers or silicon carbide composites, the method comprising:
forming the polycarbosilanes according to claim 5; and
using the polycarbosilanes as precursors for making the silicon carbide fibers or the silicon carbide composites.

19. The method of claim 18, wherein the polycarbosilanes have a ceramic yield ranging from about 60% to about 74% under inert gas upon heating to 1000° C.

20. Silicon carbide fibers or silicon carbide composites produced using the polycarbosilanes formed according to the method of claim 5.
